(19) United States
(12) Patent Application Publication
(10) Pub. No.: US 2013/0169094 A1
(43) Pub. Date: Jul. 4, 2013

(54) Rotor Lamination Structure For Permanent Magnet Machine

(71) Applicants: Seong T. Lee, Lexington, KY (US); Fang Deng, Novi, MI (US)

(72) Inventors: Seong T. Lee, Lexington, KY (US); Fang Deng, Novi, MI (US)

(73) Assignee: Danotek Motion Technologies, Inc., Canton, MI (US)

(21) Appl. No.: 13/559,330

(22) Filed: Jul. 26, 2012

Related U.S. Application Data
(60) Provisional application No. 61/581,599, filed on Dec. 29, 2011.

(51) Int. Cl. H02K 1/27

(52) U.S. Cl. 310/156.01

(57) ABSTRACT

A rotor structure is provided to block direct axis flux from a stator armature without reducing the main magnetizing flux from permanent magnet inside the rotor. For example, a rotor may be provided including a magnet and a non-magnetic region located radially between the magnet and an edge of the rotor.

### CROSS REFERENCE TO RELATED APPLICATIONS

This application claims the benefit of U.S. Provisional Patent Application No. 61/581,599 filed Dec. 29, 2011, the content of which is hereby incorporated by reference in its entirety.

### BACKGROUND

The present application generally relates to improving operation of a rotor for a permanent magnet machine.

### SUMMARY

In some implementations, a rotor for an electric machine, such as an electric generator, is provided. The rotor may include a magnetic field producing portion. The rotor may also include a non-magnetic region located radially between the magnetic field producing portion and an edge of the rotor.

In some implementations, the rotor may include a rotor portion generally having the shape of a disk. The disk may have a plurality of magnetic field producing portions equally spaced about the periphery of the disk. Each magnetic field producing portion may include at least one magnet and two ends. A first end of a first magnetic field producing portion may be adjacent to a second end of a second magnetic field producing portion. A first non-magnetic region may be located between the first end of the first magnetic field producing portion and the second end of the second magnetic field producing portion. A second non-magnetic region may be located radially between the first magnetic field producing portion and an edge of the rotor.

In all of the disclosed implementations, the rotor structure may be configured to block direct axis flux from a stator armature without reducing main magnetizing flux from a magnet inside the rotor.

Further objects, features and advantages of this application will become readily apparent to persons skilled in the art after a review of the following description, with reference to the drawings and claims that are appended to and form a part of this specification.

### BRIEF DESCRIPTION OF THE DRAWINGS

The drawings described herein are for illustration purposes only and are not intended to limit the scope of the present disclosure in any way.

FIG. 1 is a front view of an embedded permanent magnet machine with eight excitation magnetic field generating portions;

FIG. 2 is a front view of two excitation magnetic field generating portions in a rotor of the permanent magnet machine;

FIG. 3 is a front view of two excitation magnetic field generating portions in a rotor with non-magnetic regions to improve magnetic characteristics of the permanent magnet machine;

FIG. 4 is a graph of the air-gap flux density for the rotor; and

FIG. 5 is a graph of the magnitude of harmonic flux components.

It should be understood that throughout the drawings, corresponding reference numerals indicate like or corresponding parts and features.

### DETAILED DESCRIPTION

The term “about” or “generally” used herein with reference to a shape or quantity includes variations in the recited shape or quantity that are equivalent to the shape for an intended purpose or function.

A rotor lamination structure of an embedded permanent magnet synchronous machine is provided for reducing cogging torque, reducing magnet loss, and improving output power by including an air-hole between a permanent magnet of the rotor and an edge of the rotor. In addition, the rotor may have a quadrature axis air-hole.

In general, a generator is a device that generates electric power by an interacting electromagnetic force between a rotational part (rotor) and a stationary part (stator). The rotor may include an electromagnet (e.g. field coil) around a rotor-core, or permanent magnets on the surface or inside rotor-core to provide rotational magnetic flux, for example. The stator may include an armature coil around a stator core, for example. The magnet in the rotor may induce electric current in the armature coil of the stator.

Permanent magnet synchronous machines may experience magnetic loss caused by eddy currents. Eddy currents are generated due to the fluctuation of the magnetic-flux. This fluctuation is due to both slotting in stator structure (space harmonics) and non-sinusoidal current (time harmonics) flow in the stator coils.

This magnetic loss can cause temperature rise in the permanent magnets, resulting in reduced magnetic force from the permanent magnets, leading possibly to irreversible demagnetization of the permanent magnets and a significant decline of the generator overall output power.

Also, the high magnetic force of permanent magnets may cause cogging torque in the machine. Cogging torque is an undesirable feature of permanent magnet machines at starting and/or low speed operation where low frequency mechanical harmonics are introduced for vibration.

In general, magnet loss resides mainly in the region close to air-gap where the harmonic flux penetrates (measured in skin depth) and generates eddy currents. The easiest way to reduce magnet loss is to place magnets away from the air-gap. However, this will cause significant increase in magnetic flux leakage from magnets and the size of the machine and/or size and number of magnets need to be increased accordingly. The configurations disclosed may block the direct axis flux from the stator armature without reducing the main magnetizing flux from a permanent magnet inside the rotor.

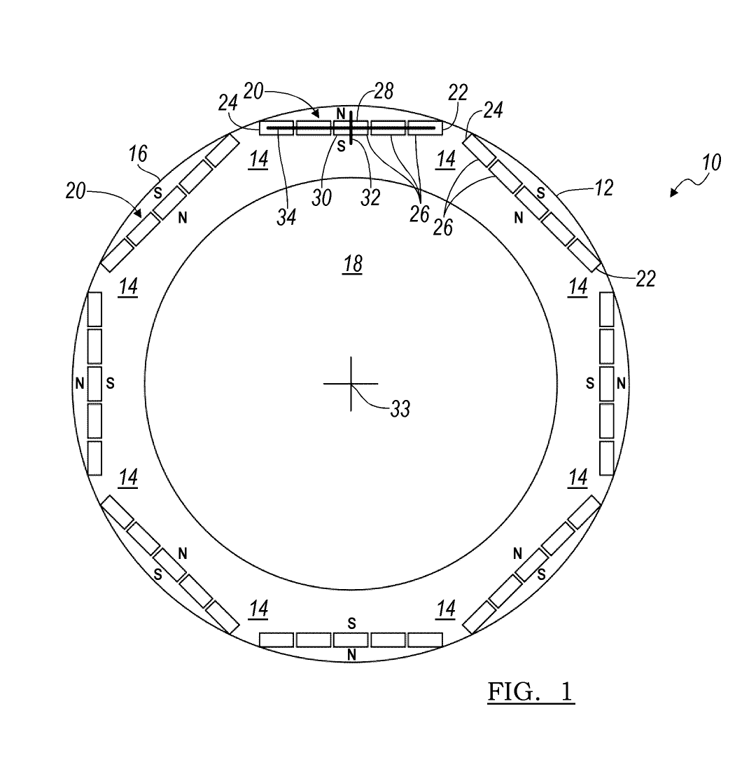

FIG. 1 illustrates a rotor 10 for an electric machine, such as an electric generator. The electric machine may be an embedded permanent magnet synchronous machine. The rotor 10 may be inside a stator. However, in other implementations, the rotor 10 may be situated outside the stator. In other implementations, the rotor 10 may also be part of a surface mount machine or a semi surface mount machine. The rotor 10 may include a plurality of stacked rotor portions each shaped as a disk or generally shaped as a disk 12. Throughout each disk 12, the rotor 10 may include a magnetic region 14 that extends to an edge 16 (e.g. outer surface) of the rotor 10. The magnetic region 14 may be made of laminated steel or other magnetic materials. The interior 18 of the rotor 10 is not shown, but may include components necessary for proper operation of the electric generator.

The rotor 10 may have eight excitation magnetic field generating portions 20 (e.g. poles) disposed in holes (e.g. banks) of the disks 12. However, any number of excitation magnetic field generating portions 20 may be used. The magnetic region 14 may surround the excitation magnetic field generating portions 20 to protect the excitation magnetic field generation portions 20 from centrifugal forces during rotation of the rotor 10, and from other forces.

Each excitation magnetic field generating portion 20 may have a first end 22 and a second end 24. A first end 22 of each excitation magnetic field generating portion 20 may be adjacent to a second end 24 of an adjacent excitation magnetic field generating portion 20.

Each excitation magnetic field generating portion 20 may have five segmented magnets 26 arrayed in a row and positioned in plane with the rotor 10. However, one or any number of magnets 26 may be used in each excitation magnetic field generating portion 20. As such, the array of magnets 26 in a row may, based on mechanical and/or manufacturing considerations, comprise a smaller or larger number than five segments. The magnets 26 may be permanent magnets, electromagnets (for example, a coil through which current is varied, thereby generating a magnetic field), or any other devices that generate magnetic fields, for example.

Each magnet 26 has a north and south magnetic poles 28, 30 that may lie along a radial direct axis 32 of the magnet 26. The radial direction may, for example, extend between the center 33 of the rotor 10 and the edge 16 of the rotor 10. Each magnet 26 also may define a quadrature axis 34, which may define an azimuthal boundary line between the north and south magnetic poles 28, 30, and which may be perpendicular to the respective direct axis 32 of the magnet 26. The azimuthal direction may, for example, extend circumferentially around the rotor, for example along a direction that passes through each of the magnetic generating portions 20. The azimuthal direction may be perpendicular to the radial direction.

Each of the magnets 26 in a given excitation magnetic field generating portion 20 may have identically oriented north and south magnetic poles 28, 30. Additionally, each excitation magnetic field generation portion 20 may have oppositely oriented north and south magnetic poles 28, 30 relative to an adjacent excitation magnetic field generating portion 20. Thus, the orientations of the north and south magnetic poles 28, may alternate around the entire circumference of the rotor 10. This is possible if there is an even number of excitation magnetic field generating portions 20. If the magnets 26 are permanent magnets, then respective magnetizations of each excitation magnetic field generating portions 20 (and their constituent permanent magnets) may alternate between radially outward and radially inward around the circumference of the rotor 10.

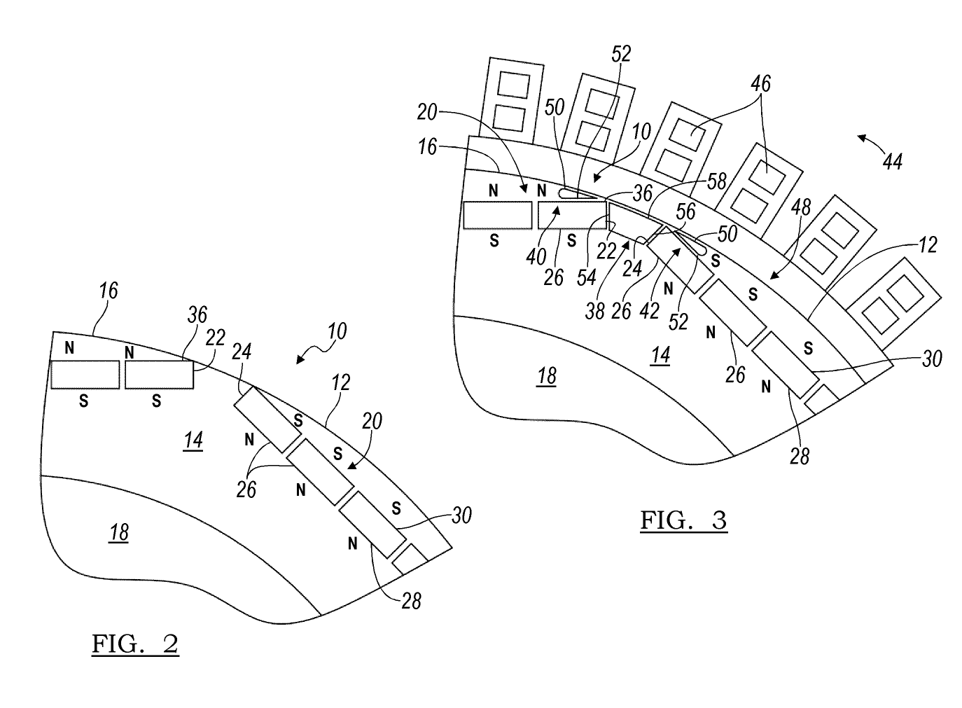

FIG. 2 illustrates a magnified view of the rotor 10, showing excitation magnetic field generating portions 20 near the edge 16 of the rotor 10. Corners 36 of the excitation magnetic field generating portions 16 may be located as close as possible to the edge 16 to minimize leakage flux from the magnets 26. However, the corners 36 may be main areas of magnet loss concentration due to their locations relative to the edge 16. For example, the corners 36 are the nearest to the stator to receive penetration of harmonic flux.

FIG. 3 illustrates a magnified view of the rotor 10 in an implementation having a number of non-magnetic regions 38, 40, 42 introduced into the rotor lamination. FIG. 3 also shows a stator 44 surrounding the rotor 10, armature coil windings 46 of the stator 44, and a gap 48 (e.g. air gap) located between the rotor 10 and the stator 44.

A first non-magnetic region 38 (e.g. a quadrature axis air hole) may be located between (e.g. azimuthally between) a first end 22 of a first excitation magnetic field generating portion 20 and the second end 24 of a second excitation magnetic field generating portion 20. Further, second and third non-magnetic region 40, 42 may respectively be located radially between the edge 16 and respective radial sides of respective magnets 26 of excitation magnetic field generating portions 20 (e.g. above corners 36 of the magnets 26).

The second and third non-magnetic region 40, 42 may also respectively be located radially between the gap 48 and respective radial sides of respective magnets 26 of excitation magnetic field generating portions 20 (e.g. above corners 36 of the magnets 26). Thus, the edge 16 may be configured to be located adjacent to the gap 48, which may be adjacent to the stator 44.

The first, second, and/or third non-magnetic regions 38, 40, 42 may be non-ferromagnetic regions, non-conductive regions, electrically non-conductive regions, a hole in the rotor, or filled with a non-magnetic material such as epoxy, for example. The first, second, and/or third non-magnetic regions 38, 40, 42 may have relative magnetic permeability values (μ/μ₀) of 1, about 1, or about the relative magnetic permeability value of air, for example. In some implementations, the first, second, and/or third non-magnetic regions 38, 40, 42 may instead be slightly magnetic regions having reduced relative magnetic permeability values compared to the relative magnetic permeability values of the surrounding magnetic regions 14 which are made of laminated steel. Further, as shown in FIG. 3, the first non-magnetic region 38 may have a trapezoidal shape or generally have a trapezoidal shape, and the second and/or third non-magnetic regions 38, 40, 42 may be have a tear-drop shape or generally have a tear-drop shape.

However, in other implementations, the first, second, and/or third non-magnetic regions 38, 40, 42, may have other shapes, for example a polygon or generally a polygon, triangle or generally a triangle, quadrilateral or generally a quadrilateral, square or generally a square, rectangle or generally a rectangle, pentagon or generally a pentagon, a hexagon or generally a hexagon, an octagon or generally an octagon, a circle or generally a circle, an oval or generally an oval, a teardrop or generally a teardrop, a trapezoid or generally at trapezoid, or an irregular shape.

Moreover, in some implementations, the first, second, and/or third non-magnetic regions 38, 40, 42 may each be split into two, three, four, or more non-magnetic regions that are spaced apart from each other by parts of the magnetic region 14. For example, the first, second and/or third non-magnetic region 38, 40, 42 may be comprised of two, three, four, or more radially spaced apart non-magnetic regions, or two, three, four, or more azimuthally spaced apart non-magnetic regions, or a 2×2 grid of non-magnetic regions 38. In particular, the non-magnetic region 38 may, for example, be optimized to increase reluctance torque by including an intrusion, as shown in the structure provided in U.S. patent application entitled “PERMANENT MAGNET ROTOR WITH INTRUSION” filed concurrently herewith, and the content of which is hereby incorporated by reference in its entirety.

In some implementations, the non-magnetic regions 38, 40, 42 may be surrounded by the magnetic region 14 of the rotor 10. As such, a first part 50 of the magnetic region 14 may be located between the non-magnetic region 40, 42 and the edge 16 of the rotor 10. Also, a second part 52 of the magnetic region 14 may be located between the non-magnetic region 40, 42 and a respective radial side of a magnet 26.

Further, a third part 54 of the magnetic region 14 may be located between a first end 22 of a first excitation magnetic field generating portion 20 and a first azimuthal side of the non-magnetic region 38, and a fourth part 56 of the magnetic region 14 may be located between a second end 24 of a second excitation magnetic field generation portion 20 and a second azimuthal side (opposing the first azimuthal side) of the non-magnetic region 38. In other implementations (not shown), opposing azimuthal sides of the non-magnetic region 38 may be flush with the first end 22 of a first excitation magnetic field generating portion 20 and a second end 24 of a second excitation magnetic field generating portion 20. Additionally, a fifth part 58 of the magnetic region 14 may be located between an outer radial side of the non-magnetic region 38 and the edge 16 of the rotor 10. However, in some implementations, the fifth part 58 may be removed, so that an inner radial side of the non-magnetic region 38 may define the edge 16 of the rotor 10.

In the configurations shown, the magnetic flux from the stator 44 can be blocked at the non-magnetic regions 40, 42. Consequently, the higher order harmonic flux from the magnets 26 (e.g. permanent magnets) may be decreased. In the meantime, the fundamental component of the magnet flux from the magnets 26 may increase a little by detouring and confining the flux to flow from both sides around, for example, the non-magnetic portions 40, 42. This reduces flux leakage in the area where the non-magnetic regions 40, 42 would otherwise be absent. As a result, the magnet loss and cogging torque may be significantly reduced due to less penetration and variation of harmonic flux from the stator 44.

Moreover, the non-magnetic region 38 (e.g. quadrature axis air hole) on the quadrature axis 34 may reduce both direct axis and quadrature axis inductances (especially reduction in quadrature axis inductance), and increase power factor of the generator. The non-magnetic region 38 may be optimized for a particular generator to render an overall high output power. The sides of the non-magnetic region 38 facing the magnets 26 in the azimuthal direction may be located close enough to the magnets 26, and the radial sides may be at the same radius as the adjacent magnets 26, to minimize magnet flux leakage and consequently output higher open circuit voltage and higher output power delivery under load.

Although the illustrated d/q structure of non-magnetic regions 38, 40, 42 and magnets 26 may be near an edge 16 of a rotor 10, with the rotor 10 being located inside a stator 44, the present disclosure is meant to encompass other d/q structures as well. For example, the d/q structure of non-magnetic regions 38, 40, 42 and magnets 26 may be near an edge of a rotor 10 and adjacent to the stator 44, with the rotor 10 being outside the stator 44.

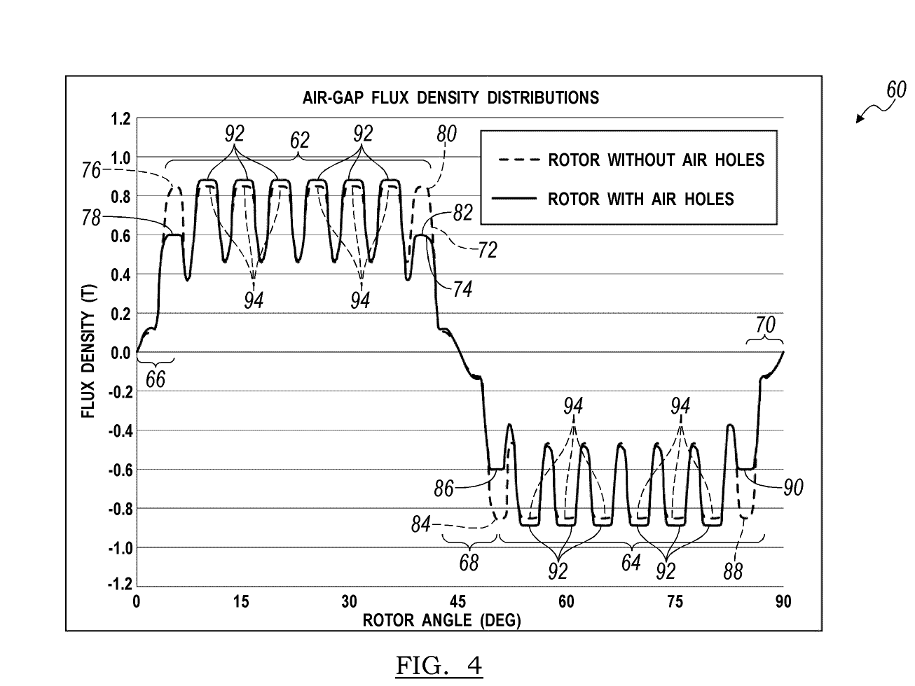

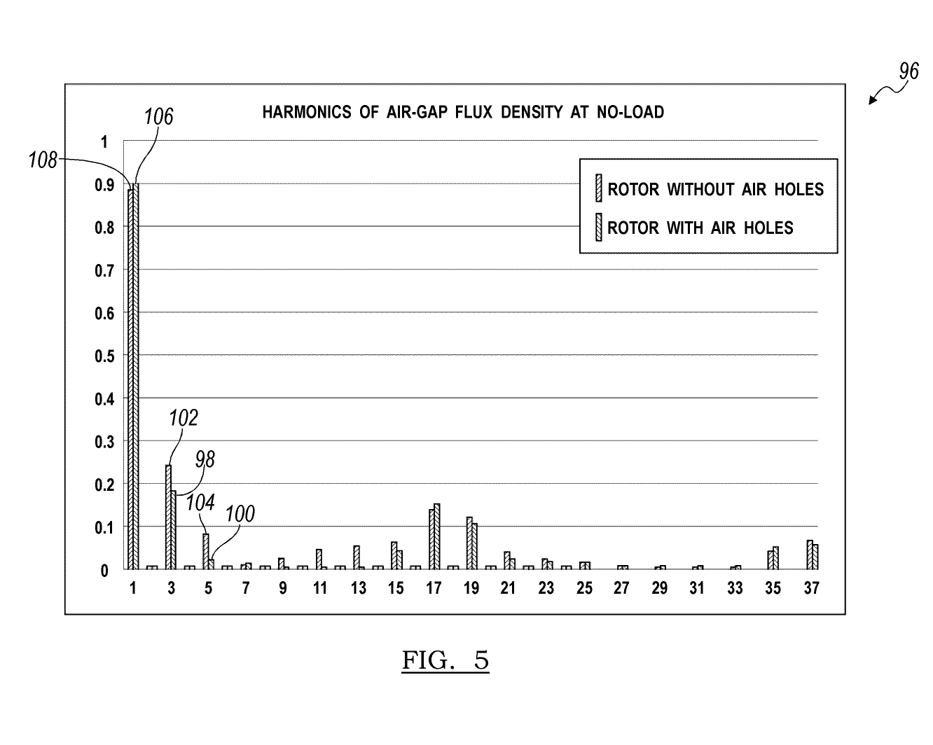

FIGS. 4 and 5 illustrate experimental results for this d/q circuit structure as applied to an embedded permanent magnet generator (EPMG) design with 2.2 MW output at 1700 rpm and a rated torque of 12000 Nm.

FIG. 4 illustrates a chart 60 showing electromagnetic analysis results provided for by Finite Elements Method (FEM). The chart regions 62, 64, which are respectively between rotor angles of about 5 to about 40 degrees and rotor angles of about 50 to about 85 degrees, show air-gap flux that may respectively correspond to first and second excitation magnetic field generating portions 20. The chart regions 66, 68, 70, which are respectively between rotor angles of about 0 to about 5 degrees, rotor angles of about 40 to about 50 degrees, and rotor angles of about 85 to about 90 degrees, show air-gap flux that may respectively correspond to three regions, each of which are between first and second ends 22, 24 of excitation magnetic field generating portions 20. The air-gap flux shown in FIG. 4 may repeat three times between about 90 degrees to about 360 degrees, and may correspond to the other six excitation magnetic field generating portions 20 of the rotor 10.

The chart line 72 shows air-gap flux that may correspond to a rotor 10 lacking non-magnetic regions 40, 42. The chart line 74 shows air gap-flux that may correspond to a rotor 10 having non-magnetic regions 40, 42. The respective parts 76, 78 of the chart lines 72, 74 shows air gap-flux that may correspond to a magnet 26 at a first end 22 of the first magnetic generating portion 20. The respective parts 80, 82 of the chart lines 72, 74 shows air gap-flux that may correspond to a magnet 26 at a second end 24 of the first magnetic generating portion 20. The respective parts 84, 86 of the chart lines 72, 74 shows air gap-flux that may correspond to a magnet 26 at a first end 22 of the second magnetic generating portion 20. The respective parts 88, 90 of the chart lines 72, 74 shows air gap-flux that may correspond to a magnet 26 at a second end 24 of the second magnetic generating portion 20. The respective parts 92, 94 of the chart lines 72, 74 shows air gap-flux that may correspond to middle parts of the magnetic generating portions 20.

The parts 78, 82, 86, 90 show, relative to the parts 76, 80, 84, 88, that introducing air holes may reduce air-gap flux (e.g. direct axis flux from the stator 44, higher order harmonic flux from the magnets 26) at ends 22, 24 of magnetic generating portions 20. The parts 92 show, relative to parts 94, that introducing air holes may also cause the fundamental component of magnet flux from the magnets 26 to increase by detouring around the non-magnetic regions 40, 42.

FIG. 5 illustrates a chart 96 showing a comparison of the magnitude of harmonic flux components between two rotors 10, one with the non-magnetic regions 40, 42 implemented as air holes, and one without the non-magnetic regions 40, 42. Near ends 22, 24 of the excitation magnetic field generating portions 20, magnetic flux is reduced, and around the middle of each excitation magnetic field generating portion 20, the flux increases. As shown in FIG. 5, the rotor 10 with non-magnetic regions 40, 42 may have a significantly smaller amount of high order harmonic flux components than a rotor without the non-magnetic regions. For example, the third and fifth harmonic component 98, 100, which are related to cogging torque and return loss, are significantly smaller than corresponding high order harmonic flux components, for example the third and fifth harmonic components 102, 104, of the rotor 10 without non-magnetic regions 40, 42. As a result, the cogging torque is greatly reduced from 1322 N.m to 699 N.m (a 47.1% reduction). Also, the total magnet loss is reduced from 2.32 kW to 1.65 kW (a 28.9% reduction) at the rated output operation. This may be accomplished without reducing the fundamental first (sinusoidal) harmonic. For example, as shown in FIG. 5, the first order harmonic 106 of the rotor 10 with non-magnetic regions 40, 42 may be greater than the first order harmonic flux 108 of the rotor 10 without non-magnetic regions 40, 42. This increased flux may, for example, correspond to the increased flux in the parts 92 of the chart line 72 that may correspond to middle parts of the magnetic generating portions 20. Additionally, as shown in FIG. 5, the seventh through thirty-seventh harmonic flux components may also be affected by introducing the non-magnetic regions 40, 42.

In the meantime, through optimization of the non-magnetic region 38 (e.g. quadrature axis air holes), the leakage flux from the magnet can be minimized to improve open circuit voltage. The applied optimized quadrature axis circuitry may improve the open circuit voltage from 757.3 V to 764.3 V and the expected output may be increased from 2.237 MW to 2.239 MW.

In the configurations shown, the magnetic flux from the stator 44 can be blocked at the non-magnetic regions 40, 42. Consequently, the higher order harmonic flux from the magnets 26 (e.g. permanent magnets) may be decreased. In the meantime, the fundamental component of the magnet flux from the magnets 26 may increase a little by detouring and confining the flux to flow from both sides around, for example, the non-magnetic portions 40, 42. This reduces flux leakage in the area where the non-magnetic regions 40, 42 would otherwise be absent. As a result, the magnet loss and cogging torque may be significantly reduced due to less penetration and variation of harmonic flux from the stator 44.

As a person skilled in the art will readily appreciate, the above description is meant as an illustration of the principles of this application. This description is not intended to limit the scope or application of this invention in that the invention is susceptible to modification, variation and change, without departing from spirit of this application, as defined in the following claims.

1. A rotor for an electric machine, the rotor comprising:
a magnet; and
a non-magnetic region located radially between the magnet and an edge of the rotor.

2. The rotor of claim 1, wherein the non-magnetic region is an electrically non-conductive region.

3. The rotor of claim 1 wherein the non-magnetic region is a hole in the rotor.

4. The rotor of claim 1 wherein the non-magnetic region is filled with epoxy.

5. The rotor of claim 1 wherein the non-magnetic region approximates a tear-drop shape.

6. The rotor of claim 1 further comprising a magnetic region located between the non-magnetic region and the edge of the rotor.

7. The rotor of claim 1 further comprising a magnetic region located between the magnet and the non-magnetic region.

8. The rotor of claim 1 further comprising:
a second magnet having an first end adjacent to a second end of the magnet; and
a second non-magnetic region located radially between the second magnet and the edge of the rotor.

9. The rotor of claim 8 wherein the non-magnetic region is a hole in the rotor, and wherein the second non-magnetic region is a hole in the rotor.

10. The rotor of claim 8 further comprising:
a first magnetic region located between the non-magnetic region and the edge of the rotor; and
a second magnetic region located between the second non-magnetic region and the edge of the rotor.

11. The rotor of claim 8 further comprising:
a third magnetic region located between the magnet and the non-magnetic region; and
a fourth magnetic region located between the second magnet and the second non-magnetic region.

12. The rotor of claim 8 further comprising a third non-magnetic region located between the magnet and the second magnet.

13. The rotor of claim 8 further comprising a magnetic region located between the magnet and the second magnet.

14. The rotor of claim 1 wherein the edge is configured to be located adjacent to a gap that is adjacent to a stator.

15. A rotor for an electric machine, the rotor comprising a rotor portion generally having the shape of a disk, the disk having a plurality of magnetic field producing portions equally spaced about the periphery of the disk, each magnetic field producing portion including at least one magnet, each magnetic field producing portion having two ends, a first end of a first magnetic field producing portion being adjacent to a second end of a second magnetic field producing portion, a first non-magnetic region being located between the first end of the first magnetic field producing portion and the second end of the second magnetic field producing portion, a second non-magnetic region located radially between the first magnetic field producing portion and an edge of the rotor.

16. The rotor according to claim 15 further comprising a third non-magnetic region being located radially between the second magnetic field producing portion and an edge of the rotor.

17. The rotor according to claim 15 wherein the second non-magnetic region is an electrically non-conductive region.

18. The rotor according to claim 15 wherein the second non-magnetic region is a hole in the rotor.

19. The rotor according to claim 15 wherein the second non-magnetic region is filled with epoxy.

20. The rotor according to claim 15 wherein the second non-magnetic region approximates a tear-drop shape.

21. The rotor according to claim 15 further comprising a magnetic region located between the second non-magnetic region and the edge of the rotor.

22. The rotor according to claim 15 further comprising a magnetic region located between the first magnet portion and the second non-magnetic region.

23. The rotor according to claim 15 wherein the first magnetic region is generally a trapezoidal shape.

24. A rotor structure configured to block direct axis flux from a stator armature without reducing main magnetizing flux from a magnet inside the rotor.
